(19) United States
(12) Patent Application Publication
(10) Pub. No.: US 2004/0112100 A1
(43) Pub. Date: Jun. 17, 2004

(54) ELECTRONIC DOOR LOCKING APPARATUS

(76) Inventor: Clifford E. MARTIN, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/605,037

(22) Filed: Sep. 3, 2003

(30) Foreign Application Priority Data
Dec. 11, 2002 (CA) 2,413,836

(51) Int. Cl. E05B 65/12; E05B 41/00

(52) U.S. Cl. 70/257; 70/432

(57) ABSTRACT

The present invention relates to an apparatus for simultaneously securing both ends of a door with a single locking action. An electric solenoid motor is used to move a first deadbolt into a locked position and an associated locking bar simultaneously moves a second deadbolt at the other end of the door into a locked position.

### BACKGROUND OF INVENTION

The present invention relates to an apparatus for simultaneously securing both ends of a door to maximize security, to prevent forcible entry.

An inherent problem with residential door locking systems is that they are often inadequate and prone to failure during forced entry. A single dead bolt system is commonly utilized in residential doors consisting of a solitary deadbolt that is mechanically actuated into a locked position with the turn of a key. In its locked position the deadbolt is inserted into a corresponding strike plate that is housed within the adjacent door-frame. Such a system is problematic for a number of reasons including its inability to withstand force such as an individual kicking or barging the door. Because there is only one deadbolt, the force of such a blow is centered at this single point resulting in the surrounding door or door-frame cracking which then compromises the integrity of the locking system. Also, the use of a proximately centered single deadbolt means that the application of extreme force at either the top or bottom of the door results in a turning motion about the deadbolt, which again results in the door and doorframe cracking under the pressure of the moment of force. Finally, conventional deadbolt systems are prone to exterior violation through the use of a variety of tools.

Various mechanisms have been developed to try and overcome the aforementioned problems. One attempted solution has been the use of multiple deadbolts. These deadbolts are either individually locked and unlocked or, connected to a single locking mechanism by complex electrical circuitry. Individual deadbolts are cumbersome and unwieldy to use and the electrically connected deadbolts are unduly complicated and expensive to both install and manufacture. Further, such systems do not overcome the potential problem of the failure of the surrounding door and door-frame housing the locking system and the potential to apply force to the side of the door without the dead bolts.

The above problems have also been addressed by certain industrial locking mechanisms that utilize the concept of multiple deadbolts that are located at each end of the door. However, such systems usually involve the use of a manually operated lever to simultaneously lock and unlock the deadbolts. This is unsightly and unsuitable for residential use and poses the further problem that it can only be operated from the interior of the building.

Electronically controlled versions of such systems have been created but these systems are unduly complicated and expensive to both install and manufacture.

Therefore there is a need in the art for a simple and inexpensive door locking mechanism to secure both ends of a door with a single locking action. This mechanism should be able to withstand the application of external force and further, the mechanism should overcome the problem of the inherent weakness of conventional doors and door frames. Finally this mechanism should be compatible with use with a conventional residential door.

### SUMMARY OF INVENTION

The present invention relates to an apparatus for simultaneously securing both ends of a door with a single locking action.

Accordingly, in one aspect of the invention, the invention comprises an apparatus comprising:

(a)a first deadbolt, positioned within the doorjamb adjacent a first door end wherein the first deadbolt is movable between a first locked position within the door end and a second unlocked position within the doorjamb;

(b)a second deadbolt, positioned within the door at a second door end, opposite the first door end, wherein the second deadbolt is movable between a first locked position and a second unlocked position;

(c)a means for actuatingmoving the first lowerdeadbolt between its locked and unlocked positions;

(d)means for actuating the second deadbolt in synchronization with the first deadbolt in response to movement by the first deadbolt or the first deadbolt actuation means.

In one embodiment, the first deadbolt is positioned above the door when in its unlocked position and engages an opening in an upper door end when in its locked position and the second deadbolt is housed within the door when in its unlocked position and engages an opening in the door jamb or floor beneath the door when in its locked position. Preferably, the first deadbolt is actuated by an electric solenoid motor.

In a further embodiment the means for actuating the second deadbolt comprises a said locking pin mechanism is comprised of a rod moveable between a first locked position and a second unlocked position, wherein a first end of the locking rod is exposed in the upper door opening when in its unlocked position and is displaced by the first deadbolt to move into its locked position when the upper deadbolt is moved into its locked position; and means for biasing the locking rod in its unlocked position. The biasing means may be a compression or coil spring.

In another embodiment the locking rod is contained within a tube affixed to the exterior of the door.

In another aspect of the invention, the invention comprises an apparatus comprising: (a)a deadbolt slidably moveable between a first locked position and a second unlocked position;

(b)reversible electric motor means for actuating movement of the deadbolt;

(c)an exterior switch operatively connected to the electric motor;

(d)an interior switch operatively connected to the electric motor;

(e)a first contact switch positioned relative to the deadbolt such that the deadbolt contacts the first contact switch when in its unlocked position, wherein the first contact switch turns off the electric motor; and

(f)a second contact switch positioned relative to the deadbolt such that the deadbolt contacts the second contact switch when in its locked position, wherein the first contact switch turns off the electric motor.

In one embodiment the electric motor may be connected to a remote switch. In another embodiment, the contact switches are indicator switches for illuminating locked and unlocked indicator lights.

### BRIEF DESCRIPTION OF DRAWINGS

The invention will now be described by way of an exemplary embodiment with reference to the accompanying simplified, diagrammatic, not to scale drawings. In the drawings:

FIG. 1 is a diagrammatic depiction of one embodiment of the invention mounted on a door in the unlocked position.

FIG. 2 is a diagrammatic depiction of one embodiment of the invention mounted on a door in the locked position.

FIG. 3 is a diagrammatic depiction of one embodiment of the invention mounted on a door illustrating the use of horizontally orientated dual locking bars.

FIG. 4 is a diagrammatic depiction of one embodiment of the inventionmounted on a door illustrating the use of dual locking bars.

FIG. 5 is a side view of the first deadbolt in an unlocked position and thelocking rod with the side portion of the exterior tube removed.

FIG. 6 is a side view of the first deadbolt in a locked position and the lockingrod with the side portion of the exterior tube removed.

FIG. 7 is a schematic view of the switch configuration of one embodiment.

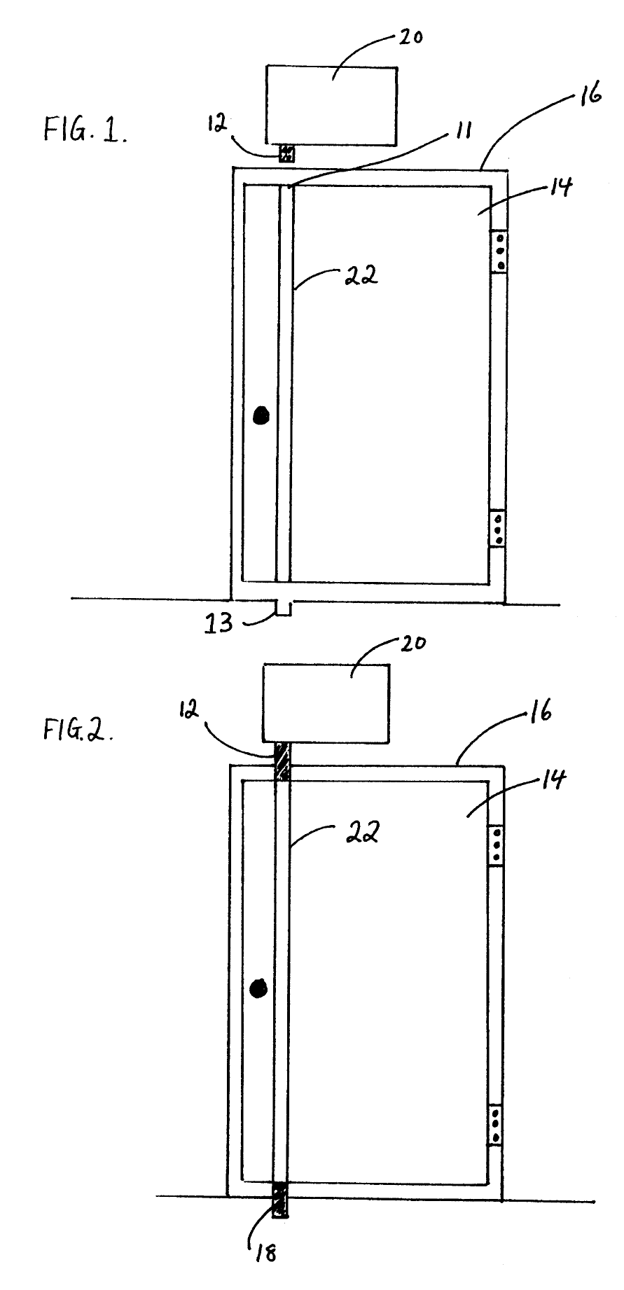

### DETAILED DESCRIPTION

The apparatus (10) according to the Figures is comprised of a first dead bolt (12) positioned within the doorjamb (16) immediately adjacent to the first end of a door (14). The first dead bolt (12) is moveable between a first locked position within the first door end and a second unlocked position within the door jamb (16). The apparatus (10) is further comprised of a second deadbolt (18) positioned within the opposite end of the door (14). The second deadbolt (18) is also moveable between a first locked postion and a second unlocked position. Finally the apparatus (10) is comprised of a means for actuating the first deadbolt (12) between its first locked position and its second unlocked position and a means for actuating the second deadbolt (18) in synchronization with the first deadbolt (12) between its first locked and second unlocked position.

In one embodiment, the first deadbolt (12) is positioned above the door end when in its unlocked position and engages an opening the upper door end (11) when moved into its locked position. In a further embodiment, the second deadbolt (18) is housed in the door (14) when in its unlocked position and engages an opening in the door jamb or floor (13) beneath the door (14) when in its locked position.

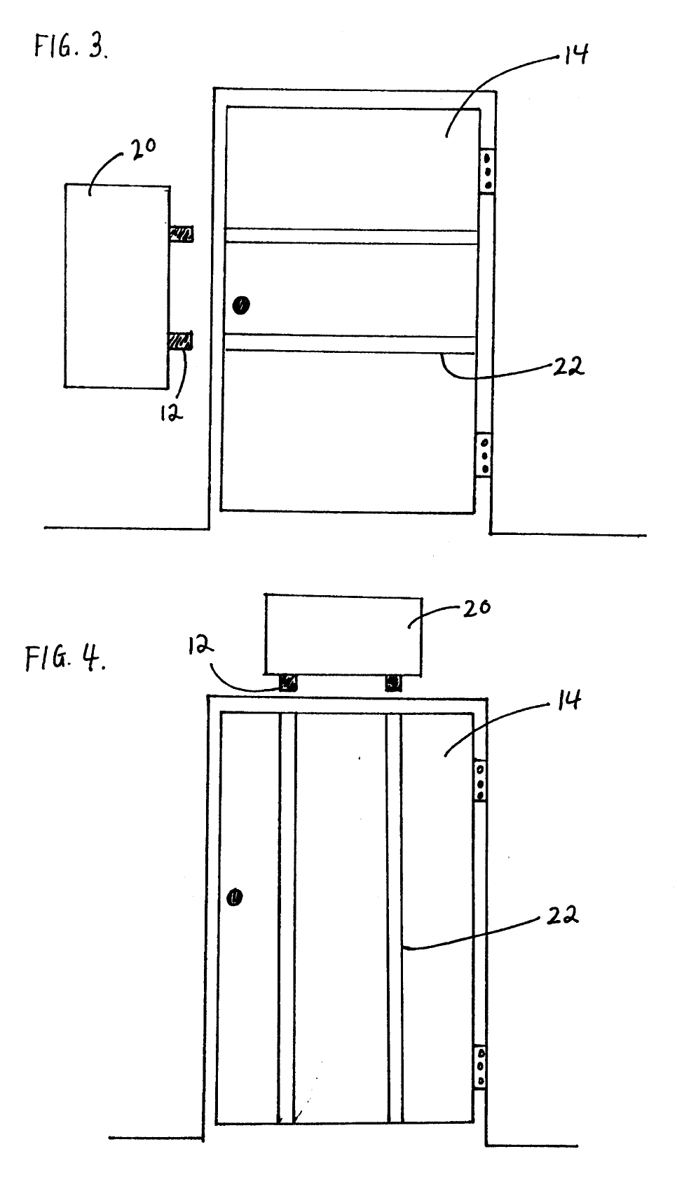

As depicted in FIGS. 3 and 4 a plurality of deadbolts may by utilized to increase the number of deadbolts securing both ends of the door (14). The greater the number of deadbolts, the more external force the door will be able to withstand. Further, as depicted in FIG. 3, the dead bolts (12, 18) may be orientated horizontally on the door (14).

The actuation means for the first deadbolt (12) may be an electric solenoid motor (20) with reversible motor means to cause the first deadbolt (12) to move between its unlocked and locked positions. As depicted in FIG. 7, a first contact switch (30) may be positioned relative to the first deadbolt (12) such that when the first deadbolt (12) is in its retracted unlocked position, the switch (30) is engaged which in turn shuts off the electric motor (20). Likewise, a second contact switch (36) may placed in a position such that it is engaged when the first deadbolt (12) moves into its locked position, which in turn causes the electric motor (20) to shut off. The electric motor (20) may also be connected to an exterior (42) and an interior switch (40) either of which, when used, will cause the electric motor (20) to activate and move the first deadbolt (12) between its locked and unlocked positions. The first contact switch (30) and the second contact switch (36) may also be indicator switches for illuminating unlocked (34) and locked (32) indicator lights. Further, the electric motor (20) may be connected to a remote control switch (38) to permit the user to lock or unlock the door (14) from a distance, either wired or wirelessly.

The actuation means for the second deadbolt (18) may be a locking rod (22) having a first locked position and a second unlocked position. In its second unlocked position the first end of the locking rod (22) is exposed in the upper door opening and is consequently displaced by the first deadbolt (12) when it moves into its locked position. This displacement causes the locking rod (22) to move into its first locked position. The locking rod (22) comprises a means for biasing the locking rod (22) into its unlocked position. The biasing means may be compression spring (24) or such other biasing means as are commonly used by one skilled in the art.

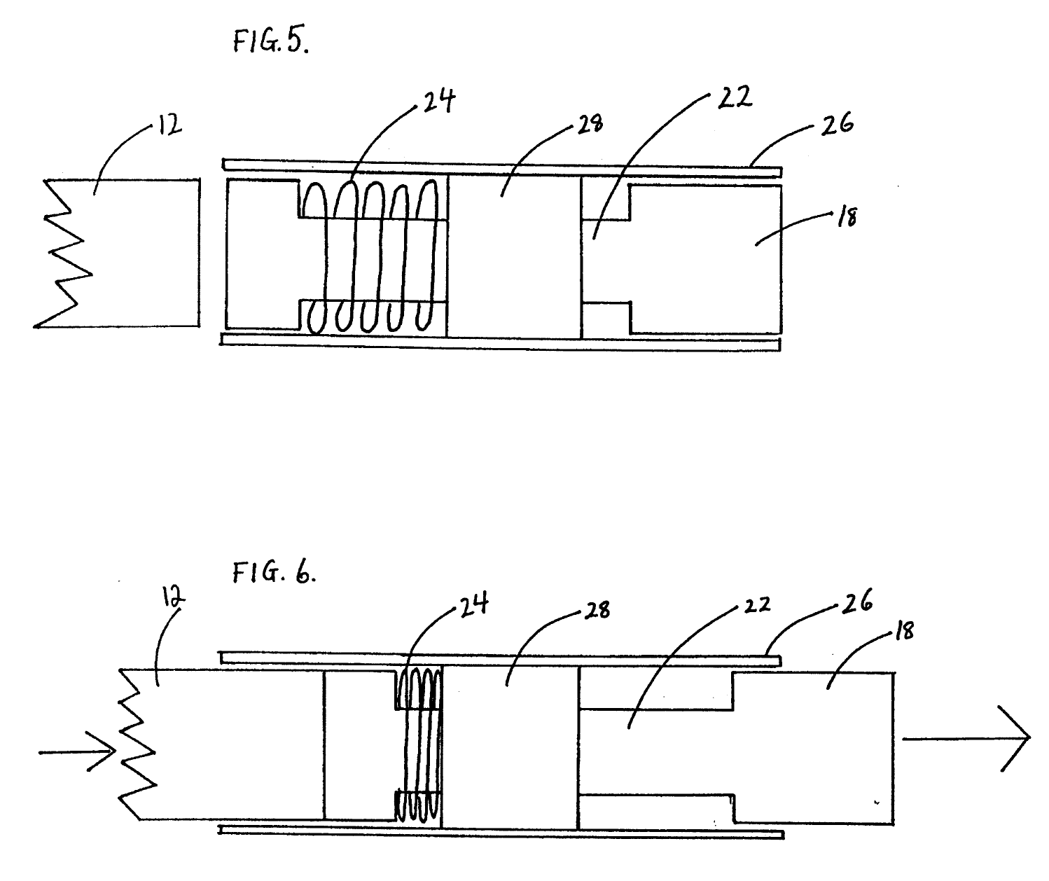

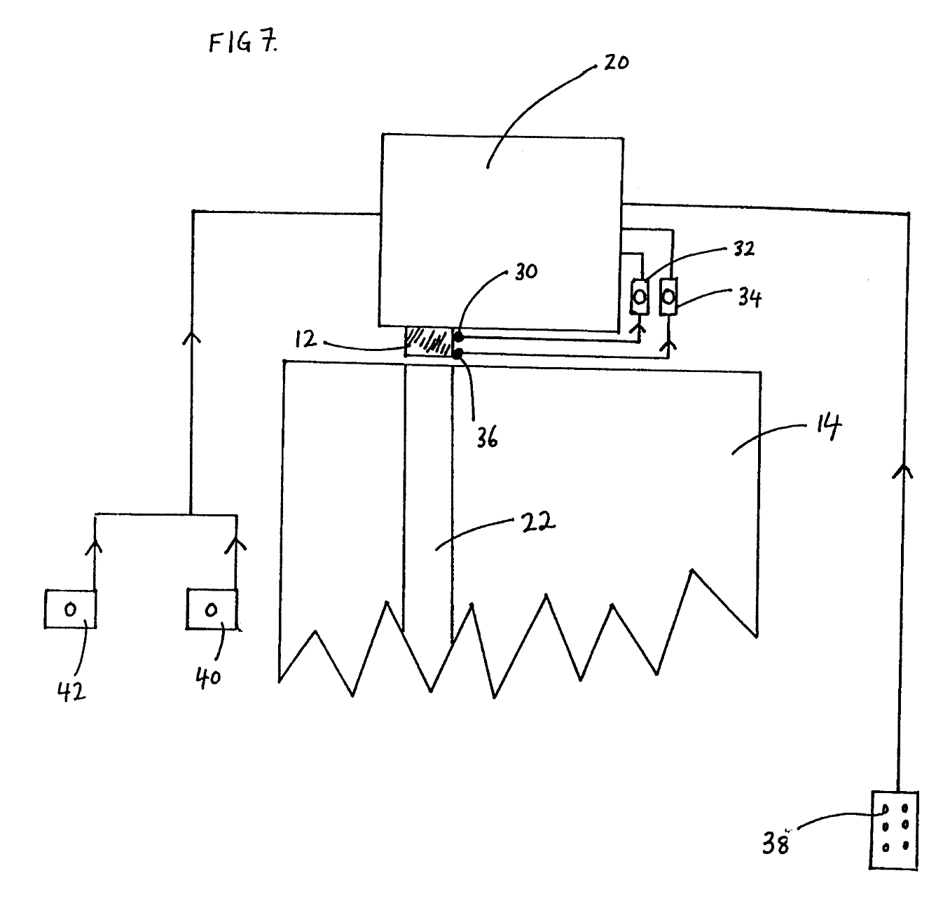

The locking rod (22) may also be housed in a tube (26) affixed to the exterior of the door (14). The tube (26) may be constructed from steel tubing, however such suggestion is not intended to be limiting to the invention claimed herein. If a compression spring (24) is utilized as the biasing means for the locking rod (22), an interior tube (28) may be used to hold the spring (24) in position within the tube (26) as is depicted in FIGS. 5 and 6.

The use and operation of the apparatus (10) will now be described with reference to FIGS. 5 and 6. To secure the door (14) the electric motor (20) is activated and the first deadbolt (12) is moved into its locked position causing it to protrude into the exterior tube (26) or door opening (11) and impinge upon the locking rod (22) as is shown in FIG. 6. The insertion of the first deadbolt (12) into the exterior tube (26) effectively secures that end of the door (14) until such time as the electric motor (20) is activated again and the first deadbolt (12) is retracted into its unlocked position. The entry of the first deadbolt (12) into the exterior tube (26) exerts pressure on the locking rod (22). The locking rod (22) is moved into the exterior tube (26) in a direction towards the opposite end of the door (14) compressing the adjacent spring (24). This pressure and corresponding movement causes the second deadbolt (18) connected to the other end of the rod (22) to be pushed out of the other end of the exterior tube (26) into its first locked position as shown in FIG. 6. The second deadbolt (18) will remain in its first locked position until such time as the first deadbolt (12) is retracted into its unlocked position. This effectively secures the other end of the door (14).

To unlock the door (14), the first deadbolt (12) is retracted into its unlocked position. As the first deadbolt (12) is retracted, the pressure on the locking rod (22) is released and the spring (24) gradually decompresses pushing the locking rod (22) back to its original position as depicted in FIG. 5. As the locking rod (22) moves to its first unlocked position the interconnected second deadbolt (18) simultaneously withdraws into the exterior tube (26) until it reaches its second unlocked position as depicted in FIG. 5.

It is anticipated the apparatus (10) as described could be adapted for commercial use or for use with other access points in a building that require securing such as windows and trap-doors. This apparatus (10) is relatively simple and inexpensive to manufacture in comparison to the existing electronic deadbolt systems. This apparatus (10) also overcomes the problem of the inherent weakness of the door and the door-frame because the deadbolts are not housed within the door-frame or the door and unlike the solitary deadbolt system, the locking rod (22) transverses the entire length or width of the door meaning that external pressure or force on the door will be absorbed by the entire length of the locking rod (22).

As will be apparent to those skilled in the art, various modifications, adaptations and variations of the foregoing specific disclosure can be made without departing from the scope of the invention claimed herein.

1. An apparatus for simultaneously securing both opposing ends of a door in a door jamb, comprising:
(a) a first deadbolt, positioned within the doorjamb adjacent a first door end wherein the first deadbolt is movable between a first locked position within the first door end and a second unlocked position within the doorjamb;
(b) a second deadbolt, positioned within the door at a second door end, opposite the first door end, wherein the second deadbolt is movable between a first locked position and a second unlocked position;
(c) means for actuating the first deadbolt between its locked and unlocked positions; and
(d) means for actuating the second deadbolt in synchronization with the first deadbolt, in response to movement by the first deadbolt or the first deadbolt actuation means.

2. The apparatus of claim 1 wherein the first deadbolt is positioned above the door when in its unlocked position and engages an opening in an upper door end when in its locked position and the second deadbolt is housed within the door when in its unlocked position and engages an opening in the door jamb or floor beneath the door when in its locked position.

3. The apparatus of claim 2 wherein the first deadbolt actuation means comprises an electric solenoid motor.

4. The apparatus of claim 2 wherein the means for actuating the second deadbolt comprises a locking rod moveable between a first locked position and a second unlocked position, wherein a first end of the locking rod is exposed in the upper door opening when in its unlocked position and is displaced by the first deadbolt to move into its locked position when the upper deadbolt is moved into its locked position.

5. The apparatus of claim 4 wherein the locking rod is contained within a tube affixed to an exterior surface of the door.

6. The apparatus of claim 5 wherein the means for biasing the locking rod comprises a coil spring acting on the locking rod, biasing it towards its unlocked position.

7. A door locking system comprising:
(a) a deadbolt slidably moveable between a first locked position and a second unlocked position;
(b) reversible electric motor means for actuating movement of the deadbolt;
(c) an exterior switch operatively connected to the electric motor;
(d) an interior switch operatively connected to the electric motor;
(e) a first contact switch positioned relative to the deadbolt such that the deadbolt contacts the first contact switch when in its unlocked position, wherein the first contact switch turns off the electric motor;
(f) a second contact switch positioned relative to the deadbolt such that the deadbolt contacts the second contact switch when in its locked position, wherein the first contact switch turns off the electric motor.

8. The door locking system of claim 7 further comprising a remote switch operatively connected to the electric motor

9. The door locking system of claim 7 wherein the first contact switch comprises an indicator switch for illuminating a unlocked indicator light

10. The door locking system of claim 9 wherein the second contact switch comprises an indicator switch for illuminating a locked indicator light.
